(19) United States
(12) Patent Application Publication
(10) Pub. No.: US 2016/0207174 A1
(43) Pub. Date: Jul. 21, 2016

(54) UNIVERSAL FIXTURE FOR BURRING MACHINE

(71) Applicant: CITIC Dicastal CO., LTD, Qinhuangdao (CN)

(72) Inventors: Weidong LIU, Qinhuangdao (CN); Wenjin SHI, Qinhuangdao (CN); Fengyan LIU, Qinhuangdao (CN); Jiandong GUO, Qinhuangdao (CN); Xiaoguang HUANG, Qinhuangdao (CN); Bowen XUE, Qinhuangdao (CN); Yongning WANG, Qinhuangdao (CN); Zhihua ZHU, Qinhuangdao (CN); Changhai LI, Qinhuangdao (CN)

(73) Assignee: CITIC Dicastal CO., LTD, Qinhuangdao (CN)

(21) Appl. No.: 15/001,795

(22) Filed: Jan. 20, 2016

(30) Foreign Application Priority Data
Jan. 20, 2015 (CN) 201510027846.9

(51) Int. Cl. B25B 5/14; B25B 5/06

(52) U.S. Cl. CPC B25B 5/14; B25B 5/061

(57) ABSTRACT

The present invention relates to a universal fixture for a burring machine, which is mainly composed of a stand, an air cylinder, an air cylinder support, a guide rail slide carriage, a linear guide rail, a connecting plate, a mounting frame, a gear, a bracing rail, a bracing rail support, positioning rolls, a press cover A, a bearing A, a shaft sleeve A, a rotation shaft A, a rack, a press cover B, a rotation shaft B and a shaft sleeve B. The universal fixture provided by the present invention can meet the requirement of the burring machine for machining a wheel and meanwhile has the characteristics of simple structure, convenient manufacture and stable performance.

### TECHNICAL FIELD

The present invention relates to a universal fixture for a wheel processing process, and in particular to a universal fixture for a burring machine.

### BACKGROUND ART

With the labor cost becomes increasingly high in the industry for manufacturing automobile wheels, the production technology is required to be higher and higher in the degree of automation, and the technology in which robots are adopted to machine wheels becomes more and more mature. In order to meet the requirement for mixed line processing of the wheels of different sizes, the university of a fixture is the problem that the automobile wheel manufacturing enterprises have to face.

### SUMMARY OF THE INVENTION

An object of the present invention is to provide a universal fixture for a burring machine.

To achieve the object described above, a technical solution of the present invention is as follows: a universal fixture for a burring machine is mainly composed of a stand, an air cylinder, an air cylinder support, a guide rail slide carriage, a linear guide rail, a connecting plate, a mounting frame, a gear, a bracing rail, a bracing rail support, positioning rolls, a press cover A, a bearing A, a shaft sleeve A, a rotation shaft A, a rack, a press cover B, a rotation shaft B and a shaft sleeve B; and is characterized in that the air cylinder support, the shaft sleeve B, the bracing rail support and the linear guide rail are fixed on the stand; the air cylinder is fixed on the air cylinder support; the connecting plate is connected with the linear guide rail through the guide rail slide carriage; the rack and the mounting frame are fixed on the connecting plate; the shaft sleeve A is fixed on the mounting frame; the positioning rolls are fixed on the rotation shaft A and can rotate around the rotation shaft B through the bearing A and the press cover A; the gear is fixed on the rotation shaft B and can rotate around the rotation shaft B through the bearing B and the press cover B; the gear and the rack are engaged, and after being charged with air, the air cylinder drives the positioning rolls to move synchronously towards a middle direction along the linear guide rail through the matching between the gear and the rack.

During actual use, a robot places a wheel onto the bracing rail of the burring machine; the air cylinder is charged with air; the positioning rolls at two sides move synchronously towards a wheel direction along the linear guide rail through the engagement between the gear and the rack; and finally, the four positioning rolls come into contact with the edge of the wheel for tightening. At this point, the loading and clamping work on the burring machine is completed, and the burring on the wheel is started.

The universal fixture provided by the present invention can meet the requirement of the burring machine for machining a wheel, and meanwhile, has the characteristics of simple structure, convenient manufacture and stable performance.

### BRIEF DESCRIPTION OF DRAWINGS

FIG. 1 is a structural schematic diagram of a universal fixture for a burring machine provided by the present invention during working.

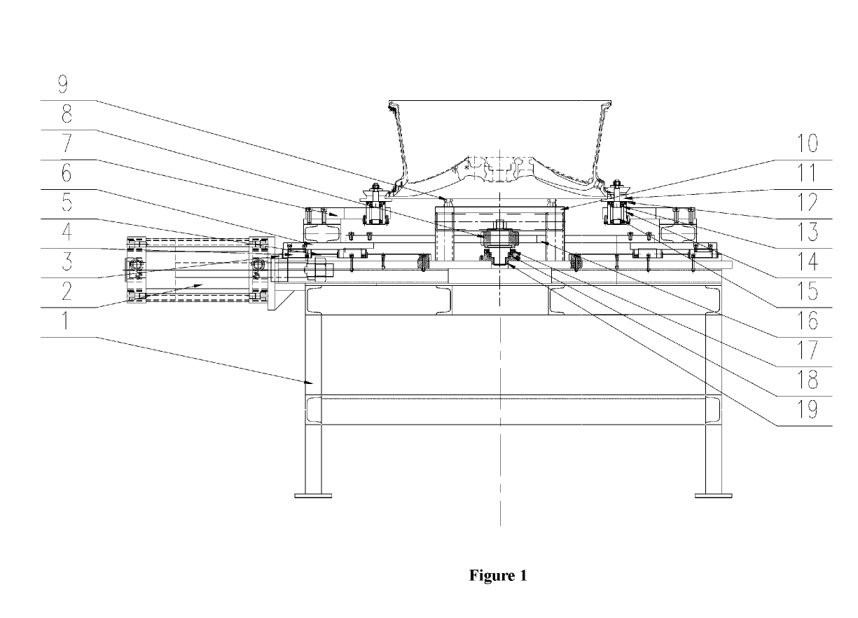

In the figure, numeric symbols are as follows: 1-stand, 2-air cylinder, 3-air cylinder support, 4-guide rail slide carriage, 5-linear guide rail, 6-connecting plate, 7-mounting frame, 8-gear, 9-bracing rail, 10-bracing rail support, 11-positioning roll, 12-press cover A, 13-bearing A, 14-shaft sleeve A, 15-rotation shaft A, 16-rack ,17-press cover B, 18-rotation shaft B, and 19-shaft sleeve B.

### DETAILED DESCRIPTION OF THE INVENTION

In the following, the details and working conditions of a specific device provided by the present invention are described in detail in combination with figures.

A universal fixture for a burring machine is mainly composed of a stand 1, an air cylinder 2, an air cylinder support 3, a guide rail slide carriage 4, a linear guide rail 5, a connecting plate 6, a mounting frame 7, a gear 8, a bracing rail 9, a bracing rail support 10, positioning rolls 11, a press cover A 12, a bearing A 13, a shaft sleeve A 14, a rotation shaft A 15, a rack 16, a press cover B 17, a rotation shaft B 18 and a shaft sleeve B 19; and is characterized in that the air cylinder support 3, the shaft sleeve B 19, the bracing rail support 10 and the linear guide rail 5 are fixed on the stand 1; the air cylinder 2 is fixed on the air cylinder support 3; the connecting plate 6 is connected with the linear guide rail 5 through the guide rail slide carriage 4; the rack 16 and the mounting frame 7 are fixed on the connecting plate 6; the shaft sleeve A 14 is fixed on the mounting frame 7; the positioning rolls 11 are fixed on the rotation shaft A 15 and can rotate around the rotation shaft B 18 through the bearing A 13 and the press cover A 12; the gear 8 is fixed on the rotation shaft B 18 and can rotate around the rotation shaft B 18 through the bearing B 19 and the press cover B 17; the gear 8 and the rack 16 are engaged, and after being charged with air, the air cylinder 2 drives the positioning rolls 11 to move synchronously towards a middle direction along the linear guide rail 5 through the matching between the gear 8 and the rack 16.

During actual use, a robot places a wheel onto the bracing rail 9 of the burring machine; the air cylinder 2 is charged with air; the positioning rolls 11 at two sides move synchronously towards a wheel direction along the linear guide rail 5 through the engagement between the gear 8 and the rack 16; and finally, the four positioning rolls 11 come into contact with the edge of the wheel for tightening. At this point, the loading and clamping work on the burring machine is completed, and the burring on the wheel is started.

1. A universal fixture for a burring machine, comprising:
a stand, an air cylinder, an air cylinder support, a guide rail slide carriage, a linear guide rail, a connecting plate, a mounting frame, a gear, a bracing rail, a bracing rail support, positioning rolls, a press cover A, a bearing A, a shaft sleeve A, a rotation shaft A, a rack, a press cover B, a rotation shaft B and a shaft sleeve B; wherein the air cylinder support, the shaft sleeve B, the bracing rail support and the linear guide rail are fixed on the stand; the air cylinder is fixed on the air cylinder support; the connecting plate is connected with the linear guide rail through the guide rail slide carriage; the rack and the mounting frame are fixed on the connecting plate; the shaft sleeve A is fixed on the mounting frame; the positioning rolls are fixed on the rotation shaft A and can rotate around the rotation shaft B through the bearing A and the press cover A; the gear is fixed on the rotation shaft B and can rotate around the rotation shaft B through the bearing B and the press cover B; the gear and the rack are engaged, and after being charged with air, the air cylinder drives the positioning rolls to move synchronously towards a middle direction along the linear guide rail through the matching between the gear and the rack.
